(19) United States
(12) Patent Application Publication
(10) Pub. No.: US 2024/0413520 A1
(43) Pub. Date: Dec. 12, 2024

(54) WIRELESS COMMUNICATION DEVICE

(71) Applicant: Panasonic Intellectual Property Management Co., Ltd., Osaka (JP)

(72) Inventors: Takahiro OCHI, Miyagi (JP); Yoshihiro KANASAKI, Ishikawa (JP); Masashi KOSHI, Ishikawa (JP); Kazutoshi HASE, Osaka (JP)

(73) Assignee: Panasonic Intellectual Property Management Co., Ltd., Osaka (JP)

(21) Appl. No.: 18/813,442

(22) Filed: Aug. 23, 2024

Related U.S. Application Data
(63) Continuation of application No. PCT/JP2022/021501, filed on May 26, 2022.

(30) Foreign Application Priority Data
Mar. 16, 2022 (JP) 2022-041108

(51) Int. Cl. H01Q 1/24; H01Q 1/22; H01Q 21/28

(52) U.S. Cl. CPC H01Q 1/241; H01Q 1/2291; H01Q 21/28

(57) ABSTRACT

A wireless communication device includes a first housing having a rectangular plate shape, a second housing having a rectangular plate shape, a connection portion that connects the first housing and the second housing, and a first GPS antenna. The first housing has an end edge having a rectangular shape, and the end edge includes a first end edge connected to the connection portion, a second end edge facing the first end edge, a third end edge connected to the first end edge and the second end edge, and a fourth end edge facing the third end edge. A first recess and a second recess are formed in the second end edge, a third recess is formed between a center of the third end edge in a longitudinal direction and the second end edge, and at least a part of the first GPS antenna is arranged in the third recess.

### TECHNICAL FIELD

The present disclosure relates to a wireless communication device.

### BACKGROUND ART

In related art, a configuration including a plurality of antennas in a wireless communication device such as a notebook personal computer or a tablet personal computer is known (see, for example, PTL 1). The wireless communication device disclosed in PTL 1 includes an antenna for a wireless local area network (LAN) and an antenna for a wireless wide area network (WAN).

### CITATION LIST

### Patent Literature

PTL 1: Unexamined Japanese Patent Publication No. 2010-45698

### SUMMARY OF THE INVENTION

The present disclosure provides a wireless communication device that includes a plurality of antennas including a Global Positioning System (GPS) antenna and is capable of securing characteristics of the GPS antenna while securing characteristics of antennas other than the GPS antenna.

A wireless communication device according to one aspect of the present disclosure includes a first housing that contains metal and has a rectangular plate shape, a display panel that is arranged in the first housing, a second housing that contains metal and has a rectangular plate shape, an input unit that is arranged in the second housing, a connection portion that connects the first housing and the second housing, a first Global Positioning System (GPS) antenna that receives a signal from an artificial satellite, and a communication circuit that is connected to the first GPS antenna, and receives a signal from the first GPS antenna. The first housing has an end edge having a rectangular shape, the end edge includes a first end edge connected to the connection portion, a second end edge facing the first end edge, a third end edge connected to the first end edge and the second end edge, and a fourth end edge facing the third end edge, and the first housing is rotatably connected to the second housing around the connection portion. The first housing includes a first recess and a second recess that are formed at the second end edge and are recessed toward an inside of the first housing, the first housing further includes a third recess that is formed between a center of the third end edge in a longitudinal direction and the second end edge, and is recessed toward the inside of the first housing, and at least a part of the first GPS antenna is arranged in the third recess.

A wireless communication device according to another aspect of the present disclosure includes a first housing that contains metal and has a rectangular plate shape, a display panel that is arranged in the first housing, a second housing that contains metal and has a rectangular plate shape, an input unit that is arranged in the second housing, a connection portion that connects the first housing and the second housing, and a first Global Positioning System (GPS) antenna that receives a signal from an artificial satellite. The first housing has an end edge having a rectangular shape, the end edge includes a first end edge connected to the connection portion, a second end edge facing the first end edge, a third end edge connected to the first end edge and the second end edge, and a fourth end edge facing the third end edge, and the first housing is rotatably connected to the second housing around the connection portion. The first housing includes a first recess and a second recess that are formed in at least one of the second end edge, the third end edge, and the fourth end edge and are recessed toward the inside of the first housing, the first GPS antenna includes a feed element having a feedpoint, and a first ground line arranged to be separated from the feed element in a longitudinal direction of the feed element, the feed element is arranged in the first recess, and the first ground line is arranged in the second recess.

According to the present disclosure, it is possible to provide the wireless communication device that includes the plurality of antennas including the GPS antenna and can ensure the characteristics of the GPS antenna while ensuring the characteristics of the antennas other than the GPS antenna.

### BRIEF DESCRIPTION OF THE DRAWINGS

FIG. 1 is a perspective view illustrating an outer appearance of a wireless communication device according to an exemplary embodiment.

FIG. 2 is a schematic layout diagram illustrating a configuration of the wireless communication device according to the exemplary embodiment.

FIG. 3 is a plan view illustrating configurations of a second GPS antenna and a first WLAN antenna according to the exemplary embodiment.

FIG. 4 is a side view illustrating the configurations of the second GPS antenna and the first WLAN antenna according to the exemplary embodiment.

FIG. 5 is a graph showing antenna efficiency of the second GPS antenna according to the exemplary embodiment.

### DESCRIPTION OF EMBODIMENT

Hereinafter, an exemplary embodiment is specifically described with reference to the drawings.

Note that, the exemplary embodiment to be described below is intended to provide comprehensive or specific examples. Numerical values, shapes, materials, components, arrangement positions and connection modes of the components, steps, order of the steps, and the like illustrated in the following exemplary embodiment are merely examples, and are not intended to limit the present disclosure.

In addition, each of the drawings is a schematic view, and is not necessarily illustrated precisely. In addition, in the drawings, same reference marks are given to the same constituent members.

### EXEMPLARY EMBODIMENT

A wireless communication device according to an exemplary embodiment will be described.

### [1. Overall Configuration]

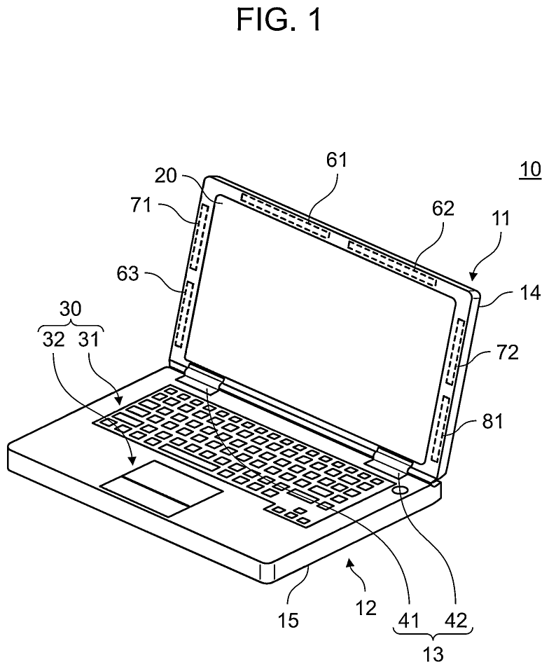

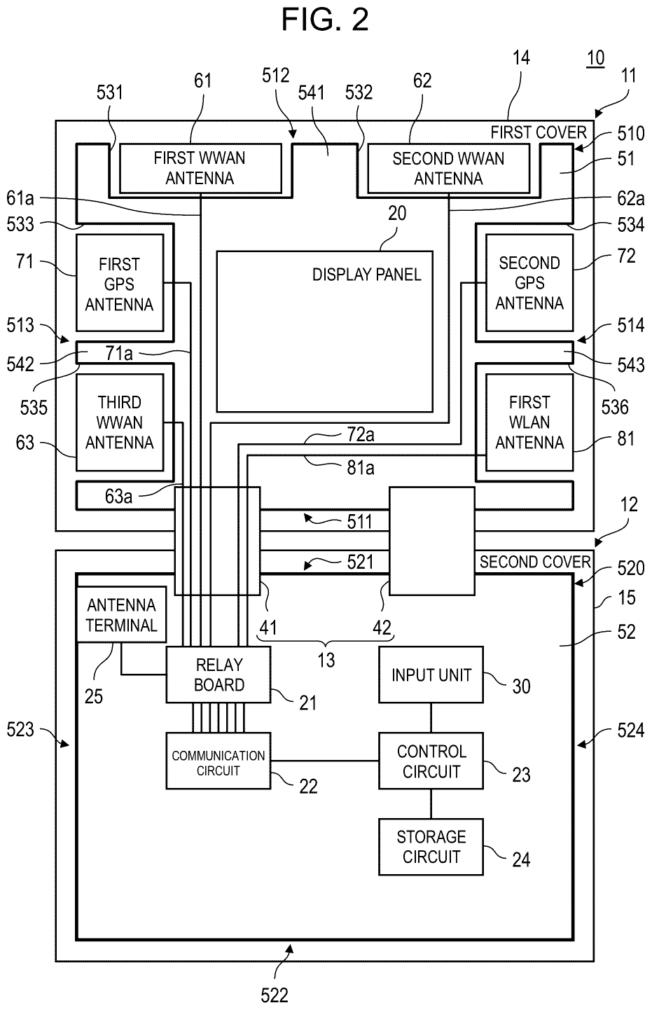

First, an overall configuration of the wireless communication device according to the present exemplary embodiment will be described with reference to FIGS. 1 and 2. FIG. 1 is a perspective view illustrating an outer appearance of wireless communication device 10 according to the present exemplary embodiment. FIG. 2 is a schematic layout diagram illustrating a configuration of wireless communication device 10 according to the present exemplary embodiment.

As illustrated in FIG. 1, wireless communication device 10 according to the present exemplary embodiment is a device that includes a plurality of antennas including first GPS antenna 71 and second GPS antenna 72 and performs wireless communication. In the present exemplary embodiment, wireless communication device 10 is a notebook personal computer (PC). As illustrated in FIG. 1, wireless communication device 10 includes first portion 11, second portion 12, and connection portion 13.

Connection portion 13 is a member that connects first portion 11 and second portion 12. As illustrated in FIGS. 1 and 2, connection portion 13 has first hinge 41 and second hinge 42.

As illustrated in FIGS. 1 and 2, first portion 11 includes first cover 14, display panel 20, first wireless wide area network (WWAN) antenna 61, second WWAN antenna 62, third WWAN antenna 63, first GPS antenna 71, second GPS antenna 72, and first wireless local area network (WLAN) antenna 81. As illustrated in FIG. 2, first portion 11 further includes first housing 51, first WWAN cable 61a, second WWAN cable 62a, third WWAN cable 63a, first GPS cable 71a, second GPS cable 72a, and first WLAN cable 81a.

First cover 14 is a member that functions as an outer shell of first portion 11. First cover 14 covers components other than a display surface of display panel 20 among the components of first portion 11. First cover 14 includes, for example, an insulating material such as resin in at least a part thereof. First cover 14 has a rectangular parallelepiped shape.

First housing 51 is a housing containing metal and having a rectangular plate shape. First housing 51 is rotatably connected to second housing 52 around connection portion 13. Consequently, a relative position of first housing 51 with respect to second housing 52 can be changed. That is, as illustrated in FIG. 1, a state of the relative position between first housing 51 and second housing 52 of wireless communication device 10 can be freely changed to a state where wireless communication device 10 is opened, a state where wireless communication device 10 is closed (a state where first housing 51 is arranged to overlap second housing 52), or the like. First housing 51 is made of, for example, metal such as magnesium. A potential of first housing 51 is a ground potential of wireless communication device 10.

In the present exemplary embodiment, first housing 51 is not a strict rectangular plate, but is a member having a substantially rectangular shape in plan view of first housing 51. First housing 51 has end edge 510 having a rectangular shape.

Rectangular end edge 510 of first housing 51 includes first end edge 511, second end edge 512, third end edge 513, and fourth end edge 514.

First end edge 511 is a portion including a portion, of rectangular end edge 510 of first housing 51, which is connected to connection portion 13.

Second end edge 512 is a portion, of rectangular end edge 510 of first housing 51, which faces first end edge 511. First recess 531 and second recess 532 that are recessed toward an inside of first housing 51 are provided in second end edge 512, and first protrusion 541 that is positioned between first recess 531 and second recess 532 and protrudes toward an outside of first housing 51. First recess 531 is formed between a center of second end edge 512 in a longitudinal direction and an end of second end edge 512 on third end edge 513 side. Second recess 532 is formed between the center of second end edge 512 in the longitudinal direction and an end of second end edge 512 on fourth end edge 514 side. In the present exemplary embodiment, first protrusion 541 is arranged at the center of second end edge 512 in the longitudinal direction.

Third end edge 513 is a portion, of rectangular end edge 510 of first housing 51, which is connected to first end edge 511 and second end edge 512. In the present exemplary embodiment, third recess 533 and fifth recess 535 that are recessed toward the inside of first housing 51 and second protrusion 542 that is positioned between third recess 533 and fifth recess 535 and protrudes toward the outside of first housing 51 are formed in third end edge 513. Third recess 533 is formed between a center of third end edge 513 in the longitudinal direction and an end of third end edge 513 on second end edge 512 side. Fifth recess 535 is formed between the center of third end edge 513 in the longitudinal direction and an end of third end edge 513 on first end edge 511 side. In the present exemplary embodiment, second protrusion 542 is arranged at the center of third end edge 513 in the longitudinal direction.

Fourth end edge 514 is a portion, of rectangular end edge 510 of first housing 51, which is connected to first end edge 511 and second end edge 512 and faces third end edge 513. In the present exemplary embodiment, fourth recess 534 and sixth recess 536 that are recessed toward the inside of first housing 51 and third protrusion 543 that is positioned between fourth recess 534 and sixth recess 536 and protrudes toward the outside of first housing 51 are formed in fourth end edge 514. Fourth recess 534 is formed between a center of fourth end edge 514 in the longitudinal direction and an end of fourth end edge 514 on second end edge 512 side. Sixth recess 536 is formed between the center of fourth end edge 514 in the longitudinal direction and an end of fourth end edge 514 on first end edge 511 side. In the present exemplary embodiment, third protrusion 543 is arranged at the center of fourth end edge 514 in the longitudinal direction.

Display panel 20 is a display device having a flat plate shape that displays an image. Display panel 20 is arranged in first housing 51. More specifically, display panel 20 is arranged at a substantially center of one principal surface of rectangular plate-shaped first housing 51 along the principal surface. Note that, although not illustrated in FIGS. 1 and 2, a signal line for controlling display panel 20, a power line for supplying power, and the like are connected to display panel 20 and is introduced into second portion 12 via connection portion 13.

First WWAN antenna 61 is a main antenna that performs wireless communication via a wireless WAN. First WWAN antenna 61 is an antenna corresponding to at least one of the fourth-generation mobile communication system (4G) and the fifth-generation mobile communication system (5G). In the present exemplary embodiment, first WWAN antenna 61 corresponds to both 4G and 5G. First WWAN antenna 61 is arranged in first recess 531 of first housing 51.

First WWAN cable 61a is a cable connected to first WWAN antenna 61. First WWAN cable 61a transmits a signal transmitted and received by first WWAN antenna 61.

Second WWAN antenna 62 is a sub antenna that performs wireless communication via a wireless WAN. Second WWAN antenna 62 is an antenna corresponding to at least one of 4G and 5G, and assists a function of first WWAN antenna 61. In the present exemplary embodiment, second WWAN antenna 62 corresponds to both 4G and 5G. In addition, second WWAN antenna 62 may include an antenna that performs wireless communication via a wireless LAN. Further, second WWAN antenna 62 may include an antenna that performs wireless communication based on the Bluetooth (registered trademark) standard. Second WWAN antenna 62 is arranged in second recess 532 of first housing 51.

Second WWAN cable 62a is a cable connected to second WWAN antenna 62. Second WWAN cable 62a transmits a signal transmitted and received by second WWAN antenna 62.

Third WWAN antenna 63 is a sub antenna that performs wireless communication via a wireless WAN. Third WWAN antenna 63 is an antenna corresponding to at least one of 4G and 5G, and assists the function of first WWAN antenna 61. In the present exemplary embodiment, third WWAN antenna 63 corresponds to both 4G and 5G. Third WWAN antenna 63 is arranged in fifth recess 535 of first housing 51.

Third WWAN cable 63a is a cable connected to third WWAN antenna 63. Third WWAN cable 63a transmits a signal transmitted and received by third WWAN antenna 63.

First GPS antenna 71 is a GPS antenna that receives a signal from an artificial satellite. In the present exemplary embodiment, first GPS antenna 71 receives signals in an L5 band (1176 MHz band) of the GPS. In addition, first GPS antenna 71 is also an antenna that performs wireless communication via a wireless WAN. First GPS antenna 71 is also used for at least one of 4G and 5G. At least a part of first GPS antenna 71 is arranged in third recess 533 of first housing 51.

First GPS cable 71a is a cable connected to first GPS antenna 71. First GPS cable 71a transmits a signal received by first GPS antenna 71.

Second GPS antenna 72 is a GPS antenna that receives a signal from an artificial satellite. In the present exemplary embodiment, second GPS antenna 72 receives signals in an L1 band (1575 MHz band), an L2 band (1227 MHz band), and an L5 band of the GPS. At least a part of second GPS antenna 72 is arranged in fourth recess 534 of first housing 51.

Second GPS cable 72a is a cable connected to second GPS antenna 72. Second GPS cable 72a transmits a signal received by second GPS antenna 72.

First WLAN antenna 81 is an antenna that performs wireless communication via a wireless LAN. In the present exemplary embodiment, first WLAN antenna 81 transmits and receives at least one signal of a 2.4 GHz band and a 5 GHz band of a wireless LAN. First WLAN antenna 81 is arranged in sixth recess 536 of first housing 51.

First WLAN cable 81a is a cable connected to first WLAN antenna 81. First WLAN cable 81a transmits a signal transmitted and received by first WLAN antenna 81.

The configurations of the antennas and the cables are not particularly limited as long as the antennas and the cables can transmit and receive signals of frequencies corresponding to applications. In the present exemplary embodiment, each antenna is a board antenna having an insulating board and a conductive film arranged on the insulating board, or a laser direst structuring antenna (LDS) having a conductive film arranged on a resin, and each cable is a coaxial cable.

In addition, each antenna has a flat plate shape arranged along a plane intersecting second housing 52 in a state where second end edge 512 of first housing 51 is closest to second housing 52 (that is, wireless communication device 10 is closed). In other words, each antenna has a flat plate shape arranged along a direction intersecting a principal surface (that is, a plane parallel to the display surface of display panel 20) of first housing 51. Consequently, the influence of second housing 52 on characteristics of each antenna can be reduced. In the present exemplary embodiment, each antenna has a flat plate shape arranged along a direction perpendicular to the principal surface of first housing 51. In other words, each antenna is arranged such that a projected area of each antenna on the principal surface of first housing 51 is minimized. Consequently, the influence of second housing 52 on the characteristics of each antenna can be minimized.

In the present exemplary embodiment, as illustrated in FIG. 2, each of the cables is introduced into second housing 52 via first hinge 41 of connection portion 13. That is, each cable is inserted into connection portion 13, one end of each cable is arranged in first housing 51, and the other end is arranged in second housing 52. Each cable is connected to relay board 21 to be described later.

As illustrated in FIGS. 1 and 2, second portion 12 includes second cover 15 and input unit 30. As illustrated in FIG. 2, second portion 12 further includes second housing 52, relay board 21, communication circuit 22, control circuit 23, storage circuit 24, and antenna terminal 25.

Second cover 15 is a member that functions as an outer shell of second portion 12. Second cover 15 covers components other than an operation surface of input unit 30 of second portion 12. Second cover 15 includes, for example, an insulating material such as resin in at least a part thereof. Second cover 15 has a rectangular parallelepiped shape.

Second housing 52 is a housing containing metal and having a rectangular plate shape. Second housing 52 is made of, for example, metal such as magnesium. Second housing 52 has the same potential as first housing 51. That is, the potential of second housing 52 is also the ground potential of wireless communication device 10 similarly to the potential of first housing 51.

In the present exemplary embodiment, second housing 52 is not a strict rectangular plate, but is a member having a substantially rectangular shape in plan view of second housing 52. Second housing 52 has end edge 520 having a rectangular shape.

Rectangular end edge 520 of second housing 52 includes first end edge 521, second end edge 522, third end edge 523, and fourth end edge 524.

First end edge 521 is a portion including a portion, of rectangular end edge 520 of second housing 52, which is connected to connection portion 13.

Second end edge 522 is a portion, of rectangular end edge 520 of second housing 52, which faces first end edge 521.

Third end edge 523 is a portion, of rectangular end edge 520 of second housing 52, which is connected to first end edge 521 and second end edge 522.

Fourth end edge 524 is a portion, of rectangular end edge 520 of second housing 52, which is connected to first end edge 521 and second end edge 522 and faces third end edge 523.

Input unit 30 is a component that is arranged in second housing 52 and is for a user of wireless communication device 10 to input information to wireless communication device 10. In the present exemplary embodiment, input unit 30 includes keyboard 31 and pointing device 32.

Relay board 21 is a board that relays communication between each antenna and communication circuit 22. First WWAN cable 61a, second WWAN cable 62a, third WWAN cable 63a, first GPS cable 71a, second GPS cable 72a, and first WLAN cable 81a are connected to relay board 21, and are connected to communication circuit 22. In the present exemplary embodiment, communication between antenna terminal 25 and communication circuit 22 is further relayed. Relay board 21 is arranged at a position closer to first hinge 41 than second hinge 42 of connection portion 13. That is, a distance from relay board 21 to first hinge 41 is shorter than a distance from relay board 21 to second hinge 42.

Communication circuit 22 is a circuit that is connected to first GPS antenna 71 and receives a signal from first GPS antenna 71. In the present exemplary embodiment, communication circuit 22 is connected to first WWAN antenna 61, second WWAN antenna 62, third WWAN antenna 63, and first WLAN antenna 81, and transmits and receives signals to and from first WWAN antenna 61, second WWAN antenna 62, third WWAN antenna 63, and first WLAN antenna 81. Further, communication circuit 22 is connected to second GPS antenna 72 and receives a signal from second GPS antenna 72. Communication circuit 22 may be arranged at the position closer to first hinge 41 than second hinge 42 of connection portion 13.

Control circuit 23 is a circuit that controls wireless communication device 10. Control circuit 23 controls display panel 20, communication circuit 22, and the like of wireless communication device 10 based on a signal from input unit 30 and the like. Control circuit 23 includes, for example, a central processing unit (CPU).

Storage circuit 24 is a circuit that stores programs, data, and the like for controlling wireless communication device 10. Storage circuit 24 may store other data. Storage circuit 24 includes, for example, a random access memory (RAM) and a read only memory (ROM).

Antenna terminal 25 is a terminal for transmitting and receiving a signal to and from an antenna arranged outside wireless communication device 10.

First hinge 41 and second hinge 42 of connection portion 13 are components that connect first housing 51 of first portion 11 and second housing 52 of second portion 12. As described above, connection portion 13 connects first portion 11 and second portion 12 by connecting first housing 51 and second housing 52.

First hinge 41 is arranged between a center of first end edge 511 of first housing 51 in the longitudinal direction and an end of first end edge 511 on third end edge 513 side. Second hinge 42 is arranged between the center of first end edge 511 of first housing 51 in the longitudinal direction and an end of first end edge 511 on fourth end edge 514 side. Each of first hinge 41 and second hinge 42 has a portion having a tubular shape, and each cable can be inserted into the tubular portion.

### [2. Antenna Arrangement]

The arrangement of the antenna according to the present exemplary embodiment will be described. As described above, the plurality of antennas included in wireless communication device 10 according to the present exemplary embodiment are arranged in the plurality of recesses of first housing 51, respectively. Each recess is a cutout portion in which a conductive material forming first housing 51 is not arranged in plan view of first housing 51. The antennas are arranged in such recesses, and thus, it is possible to reduce the influence of first housing 51 containing the conductive material on the characteristics of each antenna. In addition, in first housing 51, the plurality of recesses are positioned in a bezel (frame) region outside a region where display panel 20 is arranged. Thus, it is possible to suppress deterioration in structural strength of first housing 51 in the region where display panel 20 is arranged. In addition, since the bezel region can be effectively used by arranging the plurality of antennas in the bezel region, space saving of wireless communication device 10 can be achieved as compared with a case where a region for arranging the plurality of antennas is separately provided.

As described above, the influence of first housing 51 on the antenna characteristics can be suppressed by forming the recess in first housing 51 and arranging the antenna in the recess, but the influence of first housing 51 and the like on the antenna characteristics varies in accordance with the position of the recess. In addition, a length of the cable from the antenna to communication circuit 22 varies in accordance with the position of the recess.

First, a relationship between the position of the recess and the antenna characteristics will be described. Wireless communication device 10 is often arranged on a conductive member such as a metal desk and is used. In addition, wireless communication device 10 is often used in a state illustrated in FIG. 1. That is, wireless communication device 10 is often used in a state where a principal surface of second portion 12 is arranged to be parallel to a top surface of the desk, and first portion 11 having display panel 20 is inclined at an angle close to 90 degrees with respect to second portion 12. In addition, the hand of the user is often positioned on input unit 30 of second portion 12. Thus, among the plurality of recesses formed in first housing 51, the antenna arranged in the recess close to connection portion 13 is easily influenced by second housing 52 of second portion 12, the desk on which wireless communication device 10 is arranged, the hand of the user, and the like.

In addition, in general, second end edge 512 in which first recess 531 and second recess 532 are formed is often longer than third end edge 513 in which third recess 533 and fifth recess 535 are formed and fourth end edge 514 in which fourth recess 534 and sixth recess 536 are formed. Thus, first recess 531 and second recess 532 can often secure a larger space than the other recesses.

Accordingly, most advantageous positions for obtaining desired characteristics of the antenna are first recess 531 and second recess 532, next most advantageous positions are third recess 533 and fourth recess 534, and most disadvantageous positions are fifth recess 535 and sixth recess 536.

Next, the length of the cable from the antenna to communication circuit 22 will be described. The longer the length of the cable, the greater the attenuation of the signal and the more susceptible to noise. Thus, it is necessary to determine the arrangement of the antenna in consideration of both the antenna characteristics and the length of the cable.

In the present exemplary embodiment, all the plurality of cables connecting the plurality of antennas and relay board 21 are inserted into first hinge 41. Consequently, it is possible to prevent the cables from being caught between first portion 11 and second portion 12 and from being damaged. In addition, since relay board 21 is arranged at the position closer to first hinge 41 than second hinge 42, the length of each cable in second housing 52 can be reduced by inserting each cable into first hinge 41.

Accordingly, in the present exemplary embodiment, from the viewpoint of the length of the cable, the recess close to first hinge 41 is more advantageous than the recess far from first hinge 41. That is, first recess 531 is more advantageous than second recess 532, third recess 533 is more advantageous than fourth recess 534, and fifth recess 535 is more advantageous than sixth recess 536.

As described above, among the plurality of recesses formed in first housing 51, one of the plurality of wireless WAN antennas required to have high antenna characteristics in a wide frequency bandwidth including a relatively low frequency bandwidth is arranged in first recess 531. As the frequency bandwidth decreases, a larger antenna is required. However, since a relatively large space can be secured in first recess 531 as described above, a relatively large antenna for a low frequency bandwidth can be arranged. In the present exemplary embodiment, first WWAN antenna 61 that is a main antenna among the plurality of wireless WAN antennas is arranged in first recess 531.

Second WWAN antenna 62 that is a sub antenna among the plurality of wireless WAN antennas is arranged in second recess 532 that is next advantageous to first recess 531.

First GPS antenna 71 and second GPS antenna 72 that are required to have antenna characteristics in a relatively low frequency bandwidth are arranged in third recess 533 and fourth recess 534, respectively. First GPS antenna 71 and second GPS antenna 72 receive signals from an artificial satellite. Thus, wireless communication device 10 is positioned vertically above at the time of using the wireless communication device, and thus, the wireless communication device is less likely to be influenced by a conductive member, the body of the user, and the like arranged around the wireless communication device. Accordingly, as in the present exemplary embodiment, the GPS antennas are arranged in third recess 533 and fourth recess 534 positioned vertically above at the time of using wireless communication device 10, and thus, it is possible to suppress deterioration in antenna characteristics. In the present exemplary embodiment, since first GPS antenna 71 also serves as a WWAN antenna that performs wireless communication via a wireless WAN, first GPS antenna 71 is arranged in third recess 533 that is more advantageous than fourth recess 534.

Of third WWAN antenna 63 and first WLAN antenna 81, third WWAN antenna 63 that is required to have high antenna characteristics in a wide frequency bandwidth including a relatively low frequency bandwidth is arranged in fifth recess 535. First WLAN antenna 81 is arranged in remaining sixth recess 536.

As described above, the plurality of antennas are arranged in the plurality of recesses, respectively, and thus, desired characteristics can be obtained in each antenna. In particular, as in the present exemplary embodiment, in order to enhance the characteristics of the WWAN antenna, even in a case where the WWAN antennas are arranged in both first recess 531 and second recess 532, the GPS antenna having desired characteristics can be realized by arranging two GPS antennas in third recess 533 and fourth recess 534. That is, in the present exemplary embodiment, it is possible to realize wireless communication device 10 including the plurality of antennas including the GPS antenna and can secure the characteristics of the GPS antenna while securing the characteristics of the antennas other than the GPS antenna.

### [3. Gps Antenna]

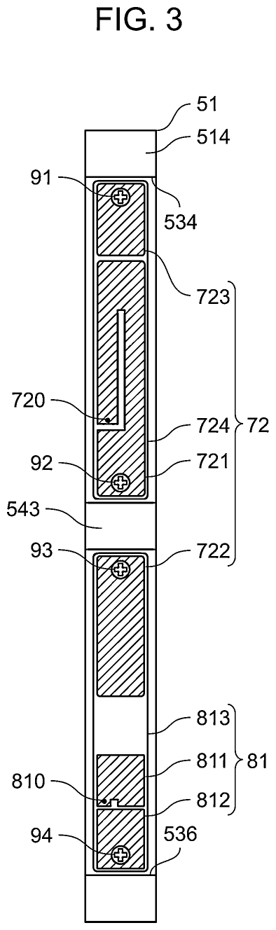

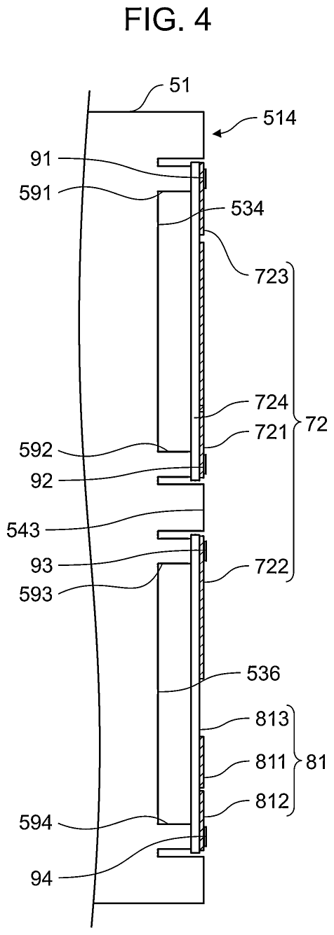

A configuration of the GPS antenna according to the present exemplary embodiment will be described with reference to FIGS. 3 and 4. FIG. 3 is a plan view illustrating configurations of second GPS antenna 72 and first WLAN antenna 81 according to the present exemplary embodiment. FIG. 4 is a side view illustrating configurations of second GPS antenna 72 and first WLAN antenna 81 according to the present exemplary embodiment.

As illustrated in FIGS. 3 and 4, second GPS antenna 72 includes board 724, feed element 721, and ground lines 722 and 723. Second GPS antenna 72 is fixed to fixing portions 591 and 592 of first housing 51 by screws 91 and 92. Screw holes corresponding to screws 91 and 92 are formed in fixing portions 591 and 592, respectively.

Board 724 is an insulating board serving as a base of second GPS antenna 72. For example, a glass epoxy board or the like can be used as board 724.

Feed element 721 is a conductive member having feedpoint 720. In the present exemplary embodiment, feed element 721 is a conductive film formed in a predetermined shape on board 724. Feedpoint 720 is a point to which a core wire of second GPS cable 72a is connected. Note that, in FIGS. 3 and 4, illustration of each cable is omitted. Feed element 721 is grounded at a position separated from feedpoint 720. In the present exemplary embodiment, first housing 51 is electrically connected via conductive screw 92.

Ground line 722 is a conductive member arranged to be separated from feed element 721 in the longitudinal direction (that is, vertical direction in FIGS. 3 and 4) of feed element 721. In the present exemplary embodiment, ground line 722 is an example of a first ground line arranged in sixth recess 536 adjacent to fourth recess 534 in which feed element 721 is arranged. In the present exemplary embodiment, third protrusion 543 is arranged between feed element 721 and ground line 722. In the present exemplary embodiment, since first WLAN antenna 81 arranged in sixth recess 536 positioned adjacent to fourth recess 534 is relatively small, ground line 722 can be arranged by using an empty space of sixth recess 536.

Ground line 722 is grounded by being electrically connected to first housing 51. Specifically, ground line 722 is electrically connected to first housing 51 via conductive screw 93. That is, ground line 722 is electrically connected to feed element 721 via screw 93, first housing 51, and screw 92. Since an electrical length between ground line 722 and feed element 721 is relatively short (that is, less than or equal to an effective wavelength of an electromagnetic wave of 1575 MHz), ground line 722 can function as a part of second GPS antenna 72. In the present exemplary embodiment, an electrical length from a point of feed element 721 electrically connected to first housing 51 (that is, a contact point between feed element 721 and screw 92) to a point electrically connected to first housing 51 on ground line 722 (that is, a contact point between ground line 722 and screw 93) is less than or equal to ½ of an effective wavelength of an electromagnetic wave received by second GPS antenna 72. In the present exemplary embodiment, in order to realize such a configuration, ground line 722 is electrically connected to first housing 51 by screw 93 at a position closer to feed element 721 than a center of ground line 722 in the longitudinal direction. In addition, feed element 721 is electrically connected to first housing 51 by screw 92 at a position closer to ground line 722 than a center of feed element 721 in the longitudinal direction. Note that, in the present application, the “effective wavelength of the electromagnetic wave” means a wavelength of the electromagnetic wave propagating in a medium. The wavelength of the electromagnetic wave propagating in the medium is shorter than a wavelength of an electromagnetic wave propagating in vacuum in accordance with a dielectric constant of the medium. This shortened wavelength is referred to as an “effective wavelength”. In FIG. 3, the effective wavelength of the electromagnetic wave received by second GPS antenna 72 may be shortened due to the influence of base materials of boards 724 and 813, resins on boards 724 and 813, and the like.

A length of ground line 722 in the longitudinal direction (that is, vertical direction in FIGS. 3 and 4) is about ¼ of the effective wavelength of the electromagnetic wave of 1575 MHz corresponding to the L1 band of the GPS. The length of ground line 722 in the longitudinal direction may be from 1/6 to 1/3, both inclusive, of the effective wavelength of the electromagnetic wave of 1575 MHz. Consequently, the signal in the L1 band in second GPS antenna 72 can resonate on ground line 722, such that the antenna efficiency in the L1 band of second GPS antenna 72 can be enhanced. Note that, the length of ground line 722 in the longitudinal direction may be about ¼ of the effective wavelength corresponding to another band of the GPS.

Ground line 723 is a conductive member arranged to be separated from feed element 721 in the longitudinal direction (that is, vertical direction in FIGS. 3 and 4) of feed element 721. Ground line 723 is an example of a second ground line arranged in fourth recess 534 together with feed element 721. Ground line 723 is grounded by being electrically connected to first housing 51. Specifically, ground line 723 is electrically connected to first housing 51 via conductive screw 91. As described above, some (board 724, feed element 721, and ground line 723) of second GPS antenna 72 are arranged in fourth recess 534, and another part (ground line 722) of second GPS antenna 72 is arranged in sixth recess 536. Similarly, a part (board, feed element, and second ground line) of first GPS antenna 71 is arranged in third recess 533, and another part (first ground line) of first GPS antenna 71 is arranged in fifth recess 535.

As illustrated in FIGS. 3 and 4, first WLAN antenna 81 includes board 813, feed element 811, and ground line 812. First WLAN antenna 81 is fixed to fixing portions 593 and 594 of first housing 51 by screws 93 and 94. Screw holes corresponding to screws 93 and 94 are formed in fixing portions 593 and 594, respectively.

Board 813 is an insulating board serving as a base of first WLAN antenna 81. For example, a glass epoxy board or the like can be used as board 813.

Feed element 811 is a conductive member having feedpoint 810. In the present exemplary embodiment, feed element 811 is a conductive film formed in a predetermined shape on board 813. Feedpoint 810 is a point to which a core wire of first WLAN cable 81a is connected.

Ground line 812 is a conductive member arranged to be separated from feed element 811 in the longitudinal direction (that is, vertical direction in FIGS. 3 and 4) of feed element 811. Ground line 812 is arranged in sixth recess 536 together with feed element 811. Ground line 812 is grounded by being electrically connected to first housing 51. Specifically, ground line 812 is electrically connected to first housing 51 via conductive screw 94.

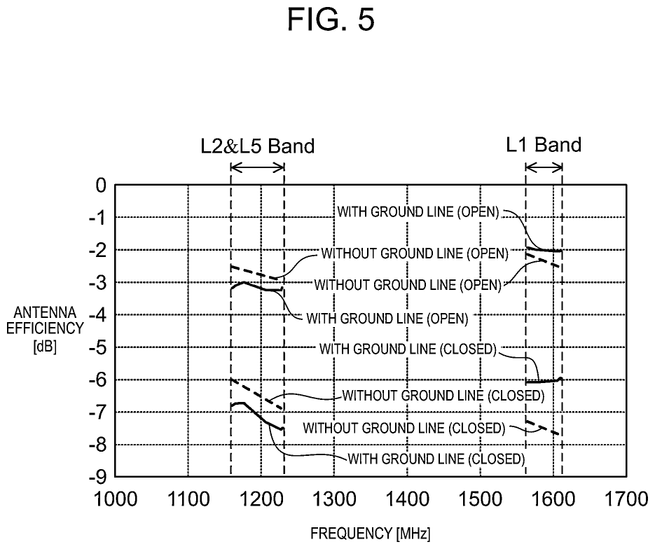

Hereinafter, an effect of second GPS antenna 72 will be described with reference to FIG. 5 while being compared with a GPS antenna of a comparative example. FIG. 5 is a graph showing antenna efficiency of second GPS antenna 72 according to the present exemplary embodiment. In FIG. 5, the antenna efficiencies of second GPS antenna 72 in the L1, L2, and L5 bands of the GPS are indicated by solid lines. A horizontal axis of the graph of FIG. 5 indicates a frequency, and a vertical axis indicates the antenna efficiency. Note that, in FIG. 5, antenna efficiencies of the GPS antenna of the comparative example are also indicated by broken lines. The GPS antenna of the comparative example is different from second GPS antenna 72 in that ground line 722 is not provided, and is identical in other points. In addition, FIG. 5 shows antenna efficiencies in a state where wireless communication device 10 is opened and a state where the wireless communication device is closed. The state where wireless communication device 10 is opened is a state where first portion 11 is inclined at an angle close to 90 degrees with respect to second portion 12 as illustrated in FIG. 1. The state where wireless communication device 10 is closed is a state where second end edge 512 of first housing 51 is closest to second housing 52. In other words, the state where wireless communication device 10 is closed is a state where the display surface of display panel 20 is brought closest to second portion 12 such that display panel 20 of first portion 11 is covered with second portion 12.

As illustrated in FIG. 5, since second GPS antenna 72 according to the present exemplary embodiment includes ground line 722, the antenna efficiencies in the L2 band and the L5 band are slightly reduced as compared with the GPS antenna of the comparative example, and the antenna efficiency in the L1 band can be greatly improved. In particular, it is possible to greatly improve the antenna efficiency in the L1 band in a state where wireless communication device 10 is closed. In a state where wireless communication device 10 is closed, since second GPS antenna 72 and second housing 52 are close to each other, antenna efficiency of second GPS antenna 72 decreases. In the present exemplary embodiment, since second GPS antenna 72 includes ground line 722, antenna efficiency in a frequency band in which resonance occurs on ground line 722 can be enhanced. In the present exemplary embodiment, since the length of ground line 722 in the longitudinal direction is about ¼ of the effective wavelength of the electromagnetic wave of 1575 MHz corresponding to the L1 band, the antenna efficiency in the L1 band can be enhanced. Since second GPS antenna 72 (and first GPS antenna 71) may be continuously used to use the positional information even in a state where wireless communication device 10 is closed, such an effect by ground line 722 is particularly beneficial.

In addition, as illustrated in FIGS. 3 and 4, second GPS antenna 72 has a flat plate shape arranged along a plane intersecting the principal surface of first housing 51. That is, in a state where wireless communication device 10 is closed (a state where second end edge 512 of first housing 51 is closest to second housing 52), second GPS antenna 72 has a flat plate shape arranged along a plane intersecting second housing 52. Consequently, the influence of second housing 52 on the characteristics of each second GPS antenna 72 can be reduced. In the present exemplary embodiment, second GPS antenna 72 has a flat plate shape arranged along the direction perpendicular to the principal surface of first housing 51. In other words, second GPS antenna 72 is arranged such that a projected area of second GPS antenna 72 on the principal surface of first housing 51 is minimized. Consequently, the influence of second housing 52 on the characteristics of second GPS antenna 72 can be minimized.

### (Modifications and Others)

Although the present disclosure has been described above based on the exemplary embodiment, the present disclosure is not limited to the above exemplary embodiment. Various modifications made on the above exemplary embodiment by those skilled in the art may be included in the present disclosure, as long as such modifications fall within the scope not departing from the spirit of the present disclosure.

For example, wireless communication device 10 according to the above exemplary embodiment includes relay board 21, but may not include relay board 21. That is, the cable connected to each antenna may be directly connected to communication circuit 22.

In addition, in the above exemplary embodiment, although second GPS antenna 72 has been described in detail, first GPS antenna 71 may have the same configuration as second GPS antenna 72. That is, the first GPS antenna may include a feed element having a feedpoint and a ground line arranged to be separated from the feed element in the longitudinal direction of the feed element. In addition, the ground line may be arranged in fifth recess 535.

In addition, first GPS antenna 71 and second GPS antenna 72 may be arranged in a recess other than the third recess and the fourth recess. That is, a first recess and a second recess that are recessed toward the inside of first housing 51 may be formed in at least one of second end edge 512, third end edge 513, and fourth end edge 514 of first housing 51, and first GPS antenna 71 or second GPS antenna 72 may be arranged in the first recess or the second recess. For example, in a case where second GPS antenna 72 is arranged in the first recess, feed element 721 may be arranged in the first recess, and ground line 722 may be arranged in the second recess. Here, ground line 722 is an example of the first ground line that is arranged apart from feed element 721 in the longitudinal direction of feed element 721 and is arranged in the second recess.

In addition, ground line 723 of second GPS antenna 72 may be arranged in the first recess. In this case, feed element 721 is arranged between ground line 722 and ground line 723. Here, ground line 723 is an example of the second ground line that is arranged to be separated from the feed element in the longitudinal direction of feed element 721 and is arranged in the first recess.

In addition, in the above exemplary embodiment, although relay board 21 is arranged at the position closer to first hinge 41 than second hinge 42, in a case where relay board 21 is closer to second hinge 42, each cable may be introduced into second housing 52 via second hinge 42. In this case, the recess closer to second hinge 42 is more advantageous for the antenna.

In addition, in the above exemplary embodiment, although connection portion 13 has only first hinge 41 and second hinge 42, connection portion 13 may have three or more hinges.

In addition, in the above exemplary embodiment, wireless communication device 10 is a notebook PC, but may be a wireless communication device other than the notebook PC. For example, wireless communication device 10 may be a clamshell smartphone or the like.

In addition, any configuration achieved by any combination of the components and the functions in the exemplary embodiment within the scope not departing from the gist of the present disclosure also falls within the scope of the present disclosure.

### INDUSTRIAL APPLICABILITY

The antenna device according to the present disclosure includes two antennas, and can be used in a communication terminal, such as a tablet terminal, a notebook PC, or a smartphone, as an antenna device capable of achieving a reduction in size while ensuring isolation between the two antennas.

### REFERENCE MARKS IN THE DRAWINGS

10: wireless communication device
11: first portion
12: second portion
13: connection portion
14: first cover
15: second cover
20: display panel
21: relay board
22: communication circuit
23: control circuit
24: storage circuit
25: antenna terminal
30: input unit
31: keyboard
32: pointing device
41: first hinge
42: second hinge
51: first housing
52: second housing
61: first WWAN antenna
61a: first WWAN cable
62: second WWAN antenna
62a: second WWAN cable
63: third WWAN antenna
63a: third WWAN cable
71: first GPS antenna
71a: first GPS cable
72: second GPS antenna
72a: second GPS cable
81: first WLAN antenna
81a: first WLAN cable
91, 92, 93, 94: screw
510, 520: end edge
511, 521: first end edge
512, 522: second end edge
513, 523: third end edge
514, 524: fourth end edge
531: first recess
532: second recess
533: third recess
534: fourth recess
535: fifth recess
536: sixth recess
541: first protrusion
542: second protrusion
543: third protrusion
591, 592, 593, 594: fixing portion
720, 810: feedpoint
721, 811: feed element
722, 723, 812: ground line
724, 813: board

1. A wireless communication device comprising:
a first housing that contains metal and has a rectangular plate shape;
a display panel that is arranged in the first housing;
a second housing that contains metal and has a rectangular plate shape;
an input unit that is arranged in the second housing;
a connection portion that connects the first housing and the second housing;
a first Global Positioning System (GPS) antenna that receives a signal from an artificial satellite; and
a communication circuit that is connected to the first GPS antenna, and receives a signal from the first GPS antenna, wherein
the first housing has an end edge having a rectangular shape,
the end edge includes a first end edge connected to the connection portion, a second end edge facing the first end edge, a third end edge connected to the first end edge and the second end edge, and a fourth end edge facing the third end edge,
the first housing is rotatably connected to the second housing around the connection portion,
the first housing includes a first recess and a second recess that are formed at the second end edge and are recessed toward an inside of the first housing,
the first housing further includes a third recess that is formed between a center of the third end edge in a longitudinal direction and the second end edge, and is recessed toward the inside of the first housing, and
at least a part of the first GPS antenna is arranged in the third recess.

2. The wireless communication device according to claim 1, further comprising:
a first wide area network (WWAN) antenna that is a main antenna that performs wireless communication via a wireless WAN; and
a second WWAN antenna that is a sub antenna that performs wireless communication via a wireless WAN, wherein
the first WWAN antenna is arranged in the first recess, and
the second WWAN antenna is arranged in the second recess.

3. The wireless communication device according to claim 2, further comprising:
a first WWAN cable that is connected to the first WWAN antenna;
a second WWAN cable that is connected to the second WWAN antenna; and
a first GPS cable that is connected to the first GPS antenna, wherein
the connection portion includes a first hinge arranged between a center of the first end edge in a longitudinal direction and the third end edge and a second hinge arranged between the center of the first end edge in the longitudinal direction and the fourth end edge, and
the first WWAN cable, the second WWAN cable, and the first GPS cable are introduced into the second housing via the first hinge.

4. The wireless communication device according to claim 3, wherein the first GPS antenna further performs wireless communication via a wireless WAN.

5. The wireless communication device according to claim 3, further comprising:
a second GPS antenna that receives a signal from an artificial satellite; and
a second GPS cable that is connected to the second GPS antenna, wherein
the first housing further includes a fourth recess that is formed between a center of the fourth end edge in a longitudinal direction and the second end edge and is recessed toward the inside of the first housing,
the second GPS antenna is arranged in the fourth recess, and
the second GPS cable is introduced into the second housing via the first hinge.

6. The wireless communication device according to claim 3, further comprising:
a third WWAN antenna that performs wireless communication via a wireless WAN; and
a third WWAN cable that is connected to the third WWAN antenna, wherein
the first housing further includes a fifth recess that is formed between the center of the third end edge in the longitudinal direction and the first end edge and is recessed toward the inside of the first housing,
the third WWAN antenna is arranged in the fifth recess, and
the third WWAN cable is introduced into the second housing via the first hinge.

7. The wireless communication device according to claim 3, further comprising:
a first WLAN antenna that performs wireless communication via a wireless local area network (LAN); and
a first WLAN cable that is connected to the first WLAN antenna, wherein
the first housing further includes a sixth recess that is formed between a center of the fourth end edge in a longitudinal direction and the first end edge and is recessed toward the inside of the first housing,
the first WLAN antenna is arranged in the sixth recess, and
the first WLAN cable is introduced into the second housing via the first hinge.

8. The wireless communication device according to claim 7, further comprising a relay board to which the first WWAN cable, the second WWAN cable, and the first GPS cable are connected and which is connected to the communication circuit, wherein the relay board is arranged at a position closer to the first hinge than the second hinge in the second housing.

9. The wireless communication device according to claim 1, wherein the first GPS antenna has a flat plate shape arranged along a plane intersecting the second housing in a state where the second end edge of the first housing is closest to the second housing.

10. The wireless communication device according to claim 1, wherein the first GPS antenna includes a feed element that is arranged in the third recess and includes a feedpoint, and a ground line that is arranged to be separated from the feed element in a longitudinal direction of the feed element and is arranged in the third recess.

11. The wireless communication device according to claim 1, wherein
the first housing further includes a fifth recess that is formed between the center of the third end edge in the longitudinal direction and the first end edge and is recessed toward the inside of the first housing, and
the first GPS antenna includes a feed element that is arranged in the third recess and includes a feedpoint, and a ground line that is arranged to be separated from the feed element in a longitudinal direction of the feed element and is arranged in the fifth recess.

12. The wireless communication device according to claim 10, wherein the ground line is electrically connected to the first housing.

13. A wireless communication device comprising:
a first housing that contains metal and has a rectangular plate shape;
a display panel that is arranged in the first housing;
a second housing that contains metal and has a rectangular plate shape;
an input unit that is arranged in the second housing;
a connection portion that connects the first housing and the second housing; and
a first Global Positioning System (GPS) antenna that receives a signal from an artificial satellite, wherein
the first housing includes an end edge having a rectangular shape,
the end edge includes a first end edge connected to the connection portion, a second end edge facing the first end edge, a third end edge connected to the first end edge and the second end edge, and a fourth end edge facing the third end edge,
the first housing is rotatably connected to the second housing around the connection portion,
the first housing includes a first recess and a second recess that are formed in at least one of the second end edge, the third end edge, and the fourth end edge and are recessed toward an inside of the first housing,
the first GPS antenna includes
a feed element having a feedpoint, and
a first ground line arranged to be separated from the feed element in a longitudinal direction of the feed element,
the feed element is arranged in the first recess, and
the first ground line is arranged in the second recess.

14. The wireless communication device according to claim 13, wherein a length of the first ground line in a longitudinal direction is from 1/6 to 1/3, both inclusive, of an effective wavelength of an electromagnetic wave received by the first GPS antenna.

15. The wireless communication device according to claim 13, wherein the first GPS antenna has a flat plate shape arranged along a plane intersecting the second housing in a state where the second end edge of the first housing is closest to the second housing.

16. The wireless communication device according to claim 13, wherein the first ground line is electrically connected to the first housing at a position closer to the feed element than a center of the first ground line in a longitudinal direction.

17. The wireless communication device according to claim 13, wherein the feed element is electrically connected to the first housing at a position closer to the first ground line than the center of the feed element in the longitudinal direction.

18. The wireless communication device according to claim 13, wherein an electrical length from a point of the feed element electrically connected to the first housing to a point of the first ground line electrically connected to the first housing is less than or equal to ½ of an effective wavelength of an electromagnetic wave received by the first GPS antenna.

19. The wireless communication device according to claim 13, wherein
the first GPS antenna further includes a second ground line that is arranged to be separated from the feed element in the longitudinal direction of the feed element,
the second ground line is arranged in the first recess, and
the feed element is arranged between the first ground line and the second ground line.

20. The wireless communication device according to claim 19, wherein the second ground line is electrically connected to the first housing.
